(19) United States
(12) Patent Application Publication
(10) Pub. No.: US 2017/0268274 A1
(43) Pub. Date: Sep. 21, 2017

(54) TILT AND TURN OR FIXED FRAME WINDOW WITH APPEARANCE OF TRADITIONAL SINGLE-HUNG OR DOUBLE-HUNG WINDOW FROM EXTERIOR

(71) Applicant: Randy C. Hoover, Winchester, VA (US)

(72) Inventor: Randy C. Hoover, Winchester, VA (US)

(21) Appl. No.: 15/462,285

(22) Filed: Mar. 17, 2017

Related U.S. Application Data
(60) Provisional application No. 62/309,747, filed on Mar. 17, 2016.

(51) Int. Cl. E05D 15/52; E06B 3/50

(52) U.S. Cl. CPC E05D 15/52; E06B 3/50; E05Y 2900/148

(57) ABSTRACT

In a tilt and turn or fixed frame window, a meeting rail unit is provided in the sash unit, dividing the sash unit vertically into an upper sash portion and a lower sash portion, the meeting rail unit having an upper portion for securing an upper glazing unit in the upper sash portion, and a lower portion for securing a lower glazing unit in the lower sash portion. An upper glazing unit secured in the upper sash portion of the sash unit, and a lower glazing unit secured in the lower sash portion of the sash unit. The meeting rail unit is configured to provide an offset between the upper glazing unit and the lower glazing unit in a direction perpendicular to the horizontal axis and to the vertical axis. An outside surface of the upper sash portion and an outside surface of the lower sash portion lie on the same plane.

### CROSS-REFERENCE TO RELATED APPLICATION

This application is a non-provisional application that claims benefit of provisional application No. 62/309,747, filed Mar. 17, 2016, the entire content of which is incorporated herein by reference.

### BACKGROUND OF THE INVENTION

While the application of PVC single-hung or double-hung windows in renovations of buildings with historical importance are technically possible, many of these renovations require much higher performing window designs including those that are commercially rated. Many PVC single and double hung designs do not attain commercial ratings and would therefore be unsuited to these applications.

European style PVC tilt and turn window designs achieve excellent structural, thermal and sound insulating performance, can be fabricated in large sizes, require fewer profiles to stock and in general have more robust design properties than most hung sash windows.

The tilt and turn window style originated in Germany in the 20th century, and its popularity quickly spread throughout Europe and is now found on almost every continent. Tilt and turn windows can be constructed using wood, aluminum or uPVC.

The basic function of a tilt and turn window is that it can tilt inwards at the top or it can be opened inwards from hinges at the side. The “tilt” mode provides the primary operating function of the window and the main benefit of this is that it allows safe and secure ventilation in practically any weather. Accessing the tilt mode is generally made possible by turning the handle 90° and pulling in on it, allowing the top of the sash to gently tilt inwards. When the sash is tilted in, the space created across the top of the window is generally 4″ to 6″ and as such, there is practically no possibility for an intruder to manipulate the sash to gain space to enter the building. In addition, the tilt mode limits the venting area to the top of the window which can generally prevent rain from entering the building especially if the window is set back in the wall or positioned under an overhang or roof eave.

The secondary operating function of a tilt and turn window is the “turn” mode. Accessing the turn mode is generally made possible by turning the handle 180°, and pulling to the left or right (depending on the handing of the unit) which allows the sash to freely swing inwards. In turn mode, the main benefit is that the sash can be swung fully into the building room which allows the exterior pane of glass to be cleaned safely from the inside of the building. Turn mode is not intended for ventilating. Turn mode also allows escape/egress capability from the interior of a building on the ground floor or other safe platform in case of emergency.

As is well-known in the art, both modes of operation described above are made possible by highly engineered hardware; available from many specialized suppliers world-wide, that consists of a series of sliding stainless steel bands enclosed in rigid steel bars that operate multiple locking cams. The locking bars are mounted around the perimeter of the sash and work in combination with the locking cams by way of opposing keepers that are mounted on the frame. The locking mechanisms; once installed on the sash and the frame, are operated by a single handle on the interior of the sash which provide a means to tilt or turn the sash from the locked position. Hinges are generally incorporated into the locking bar mechanisms and can be slightly visible from inside the building or they can be fully concealed depending on what hardware brand/manufacturer that is chosen.

Tilt and turn hardware is also available in a few different configurations such as turn first then tilt and also tilt only. The tilt only configuration is basically tilt and turn hardware that has a lock-out mode for turn mode which can be accessed by maintenance or janitorial personnel for cleaning or repairs by using a key. Windows using this configuration would be commonly found in high-rise applications or in institutional buildings.

Another important benefit of tilt and turn windows is that the sash and frame use up to three compression seals around the full perimeter of the window unit. Much like the way a typical car door or refrigerator door is sealed, compression seals provide superior protection against air and water infiltration. As such, tilt and turn windows are generally some of the highest performing fenestration products available.

Some European style PVC tilt & turn window designs are meant for residential as well as commercial uses; for example, the REHAU System 4500 (sold by the applicant/assignee of the subject application, REHAU of Leesburg, Va.) is a popular choice for commercial as well as institutional applications by being able to have limited ventilation possibilities for the building occupants. The design of the hardware mechanisms can be configured to limit the sash operation to tilt only, allowing safe and secure ventilation at the top, making the window safe for use on upper floors of buildings. In this mode, the mechanisms can be unlocked by maintenance or janitorial personnel for cleaning or general maintenance.

A conventional tilt and turn window is described in U.S. Pat. No. 3,911,621 to McHeffey, the contents of which are incorporated herein by reference.

The REHAU System 4500 window design (see the “EUROPEAN-STYLE WINDOWS & DOORS, REHAU System 4500” brochure, © 2015 REHAU, the contents of which are incorporated herein by reference) includes the option of having a t-mullion profile to be used horizontally within a sash that can be positioned to divide the glazing area into two separate openings. From a distance, viewed from the exterior, the t-mullion has a similar appearance to the meeting rail at the middle of a hung sash window. However, the t-mullion does not satisfy most historical or architectural aesthetic requirements and does not sufficiently mimic the appearance of a traditional single-hung or double-hung window from the exterior as it offers no offset from upper glass to lower glass.

### SUMMARY OF THE INVENTION

It is still desired to provide a tilt and turn (such as the REHAU System 4500 tilt & turn window) or fixed frame window with the appearance of a traditional single-hung or double-hung window from the exterior of a building.

In one aspect of the present invention, the invention relates to a tilt and turn window. The tilt and turn window includes a frame configured to be fixed to a building structure; a sash unit cooperating with the frame; a tilt mechanism attached to the frame and the sash unit configured to enable the sash unit to tilt about a horizontal axis to permit a top of the sash to tilt inwardly into the building structure to provide an opening between the top of the sash and the frame for ventilation; and a turn mechanism attached to the frame and the sash unit configured to enable the sash unit to turn about a vertical axis at one side of the sash unit. According to the present invention, a meeting rail unit is provided in the sash unit, dividing the sash unit vertically into an upper sash portion and a lower sash portion, the meeting rail unit having an upper portion for securing an upper glazing unit in the upper sash portion, and a lower portion for securing a lower glazing unit in the lower sash portion. An upper glazing unit secured in the upper sash portion of the sash unit, and a lower glazing unit secured in the lower sash portion of the sash unit. The meeting rail unit is configured to provide an offset between the upper glazing unit and the lower glazing unit in a direction perpendicular to the horizontal axis and to the vertical axis.

In another aspect of the present invention, the invention relates to a fixed frame window. The fixed frame window includes a frame configured to be fixed to a building structure and a sash unit fixed to the frame. According to the present invention, a meeting rail unit is provided in the sash unit, dividing the sash unit vertically into an upper sash portion and a lower sash portion, the meeting rail unit having an upper portion for securing an upper glazing unit in the upper sash portion, and a lower portion for securing a lower glazing unit in the lower sash portion. An upper glazing unit secured in the upper sash portion of the sash unit, and a lower glazing unit secured in the lower sash portion of the sash unit. The meeting rail unit is configured to provide an offset between the upper glazing unit and the lower glazing unit in a direction perpendicular to the horizontal axis and to the vertical axis. An outside surface of the upper sash portion and an outside surface of the lower sash portion lie on the same plane.

### BRIEF DESCRIPTION OF THE DRAWINGS

FIG. 1 is a perspective view showing the appearance of a portion of one embodiment of a tilt and turn window according to the present invention, when viewed from what is intended to be the exterior side.

FIG. 2 is a front elevational view of a first embodiment of the present invention as viewed from what is intended to be the interior side. FIG. 2A is an enlarged cross-sectional view taken along line A-A of FIG. 2. FIG. 2B is an enlarged cross-sectional view taken along line B-B of FIG. 2.

FIG. 3 is a front elevational view of a second embodiment of the present invention as viewed from what is intended to be the interior side. FIG. 3A is an enlarged cross-sectional view taken along line A-A of FIG. 3. FIG. 3B is an enlarged cross-sectional view taken along line B-B of FIG. 3.

### DETAILED DESCRIPTION OF THE PREFERRED EMBODIMENTS

Various embodiments of the present invention are described below and illustrated in the accompanying drawings. However, clearly the present invention can be accomplished with other designs as would be appreciated by those skilled in the art based on this disclosure. Therefore, the following embodiments are only exemplary and are not intended to limit the scope of the invention set forth in the claims.

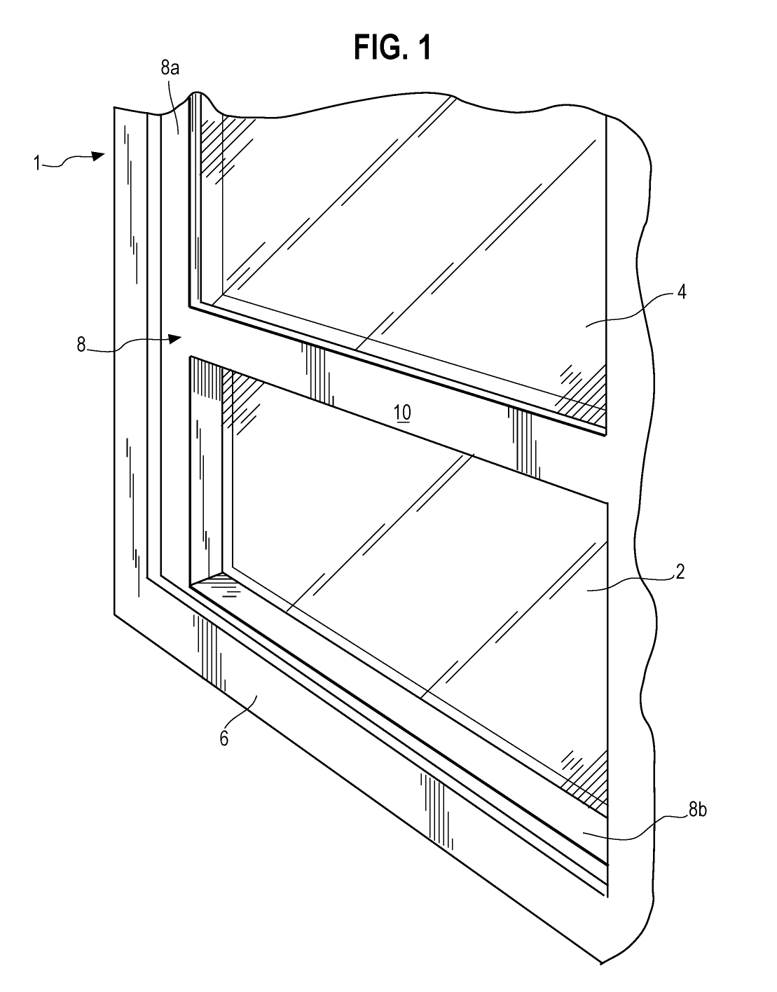

The present invention provides a tilt and turn window or fixed frame window with a meeting rail unit configured to provide an offset between the upper glazing unit and the lower glazing unit in a direction perpendicular to the horizontal axis and to the vertical axis. This simulates a meeting rail that is common on single and double-hung windows. That is, when viewed from the exterior side of a building so equipped, the offset mimics the appearance of the offset (inset) lower sash common to single-hung and double-hung windows. FIG. 1 is a perspective view, when viewed from what is intended to be the exterior side, showing the appearance of one embodiment of a tilt and turn or fixed frame window 1 according to the present invention in which the lower glazing unit 2 is offset with respect to the upper glazing unit 4 in a direction perpendicular to the horizontal axis and to the vertical axis. According to this embodiment, the lower glazing unit 2 is offset inwardly with respect to the upper glazing unit 4 in a direction perpendicular to the horizontal axis and to the vertical axis to provide the tilt and turn or fixed frame window 1 with the appearance of a traditional single-hung or double-hung window from the exterior of a building. Of course, if desired, the lower glazing unit 2 can be offset outwardly with respect to the upper glazing unit 4 in a direction perpendicular to the horizontal axis and to the vertical axis.

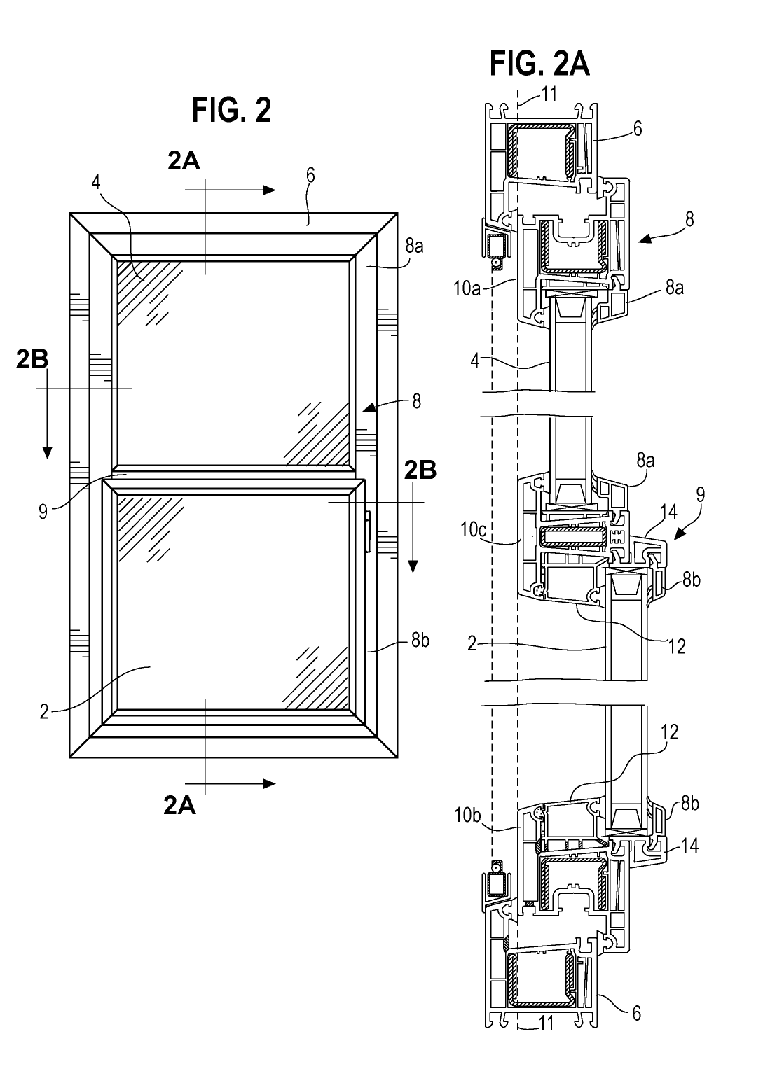

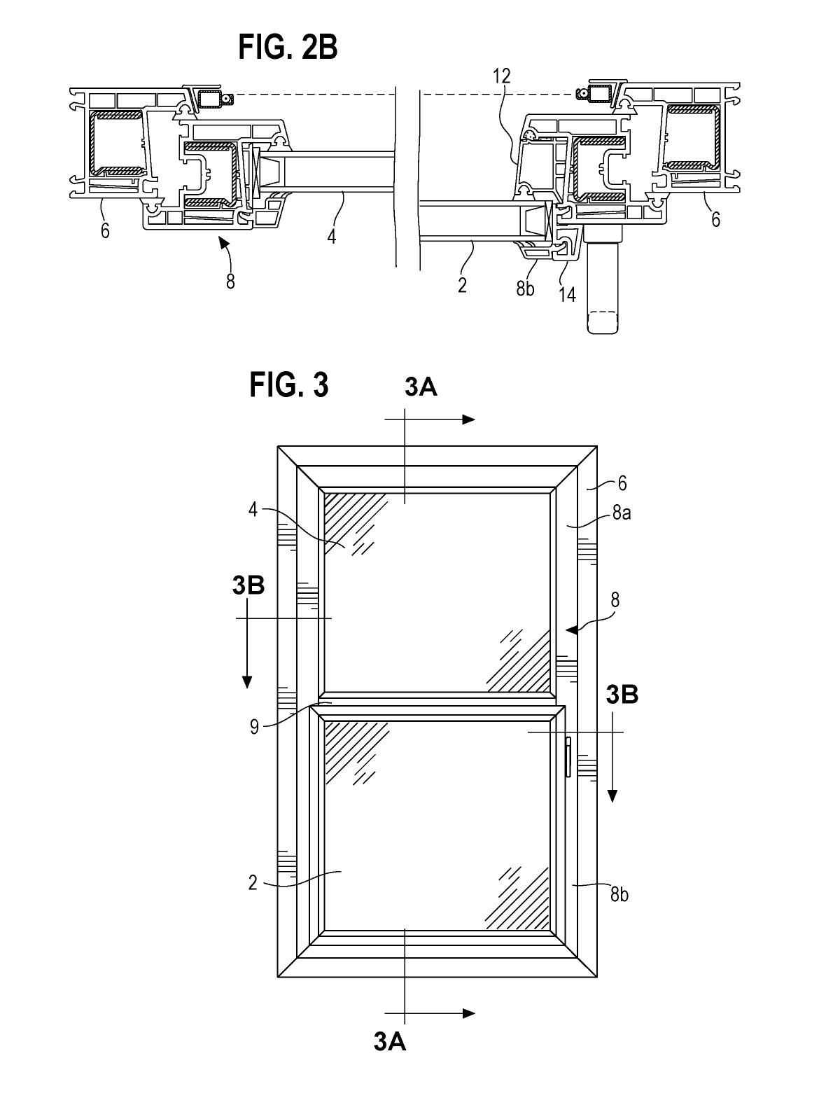

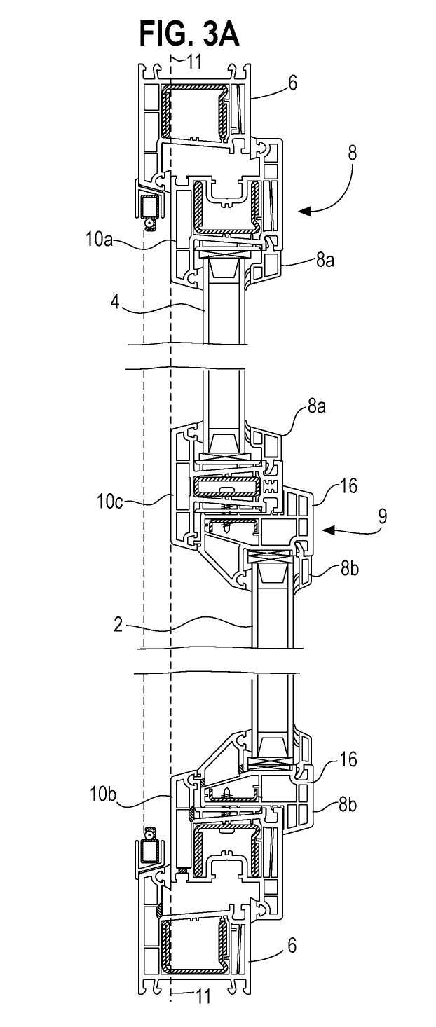

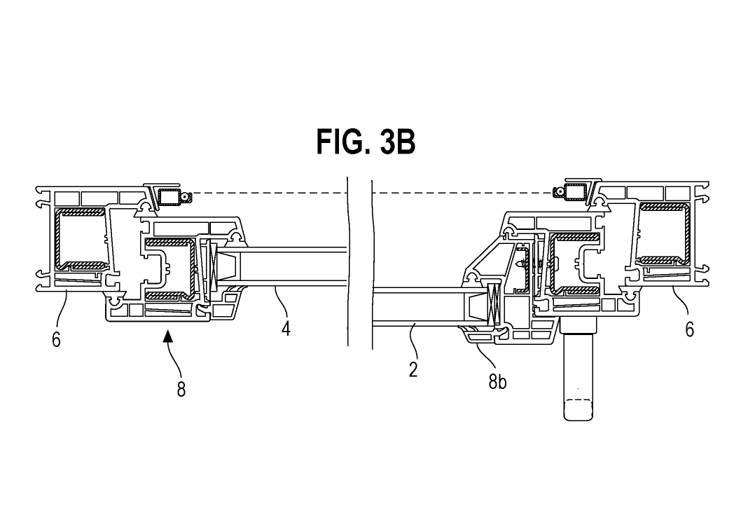

According to a first embodiment of the present invention, shown in FIGS. 2, 2A and 2B, a conventional tilt and turn window, e.g., the REHAU System 4500 tilt & turn window, or a conventional fixed frame window is modified with two extruded profiles to create the simulated single-hung or double-hung aesthetic. According to a second embodiment of the present invention, shown in FIGS. 3, 3A and 3B, a single extruded profile is used to perform the same function. Other designs are possible as would be appreciated by those skilled in the art based on this disclosure.

In both embodiments of the present invention, the window 1 includes a frame 6 configured to be installed into an opening in a wall or the like a building structure as is well-known in the art. A sash unit 8 cooperates with the frame 6 when the window 1 is a tilt & turn window and is fixed in the frame 6 when the window 1 is fixed frame window. A meeting rail unit 9 provided in the sash unit 8 divides the sash unit 8 vertically into an upper sash portion 8a and a lower sash portion 8b. The meeting rail unit 9 has an upper portion for securing an upper glazing unit 4 in the upper sash portion 8a, and a lower portion for securing a lower glazing unit 2 in the lower sash portion 8b such that the upper glazing unit 4 is secured in the upper sash portion 8a of the sash unit 8; and a lower glazing unit 2 is secured in the lower sash portion 8b of the sash unit 8.

In the tilt and turn embodiments, a tilt mechanism is attached to the frame 6 and the sash unit 8 configured to enable the sash unit 8 to tilt about a horizontal axis to permit a top of the sash to tilt inwardly into the building structure to provide an opening between the top of the sash 8 and the frame 6 for ventilation. In the tilt and turn embodiments, a turn mechanism is attached to the frame 6 and the sash unit 8 configured to enable the sash unit 8 to turn about a vertical axis at one side of the sash unit 8. Any tilt and turn mechanism can be used, such as well-known tilt and turn mechanisms being conventionally used by applicant and others, e.g., the known tilt and turn mechanism described in U.S. Pat. No. 3,911,621 to McHeffey, the contents of which are incorporated herein by reference.

In the embodiments of the present invention exemplified in the drawings, an outside surface 10a of the upper sash portion 8a and an outside surface 10b of the lower sash portion 8b lie on the same plane 11. Additionally, in the embodiments of the present invention exemplified in the drawings, an outside surface 10c of the meeting rail unit 9 also lies on the same plane 11 as the outside surface 10a of the upper sash portion 8a and the outside surface 10b of the lower sash portion 8b.

As previously noted, the meeting rail unit 9 has an upper portion for securing an upper glazing unit 4 in the upper sash portion 8a, and a lower portion for securing a lower glazing unit 2 in the lower sash portion 8b such that the upper glazing unit 4 is secured in the upper sash portion 8a of the sash unit 8; and a lower glazing unit 2 is secured in the lower sash portion 8b of the sash unit 8. The first embodiment of the invention, shown in FIGS. 2, 2A and 2B, uses two profiles described below to accomplish this. One profile or glazing rebate filler, 12 is cut into four pieces; two verticals and two horizontals, and are inserted into the window sash below the horizontal “t”-mullion. This profile or glazing rebate filler 12, when inserted, provides, e.g., a 1 3/16″ (29.8 mm) offset and provides a surface for placing and sealing the lower glazing unit 2. This creates the offset from the upper glazing unit 4 to the lower glazing unit 2.

A second profile, or glazing rebate extension, 14 is also cut into four pieces, miter cut to 45° on the ends, and snaps into the channel of the sash and the t-mullion otherwise used for the glazing stop on a standard window. The profile essentially extends the glazing stop channel 20 mm to the interior side of the sash which is required due to the offset created by the aforementioned glazing rebate filler profile 12. The combination of these two profiles 12, 14 allows the use of the same insulated glazing unit thickness (1.00″/25.4 mm) in both top and bottom openings.

In a second embodiment of the invention shown in FIGS. 3, 3A and 3B, only one extruded PVC profile 16 will take the place of both of the profiles 12, 14 described in the first embodiment. This single profile 16 will be measured to fit the dimensions of the opening below the t-mullion, they will be miter cut (45°) on each end into four pieces and will then be fusion welded to form a “sub-sash.” Normal procedures for cleaning/processing the welded corners for proper fit and appearance will be followed and the finished “sub-frame” would be fitted into the space below the horizontal t-mullion. The “sub-sash” would then be sealed with silicone to prevent air and water leakages and secured with screws into the sash and t-mullion. Standard REHAU glazing procedures would then be followed to complete the assembly. The offset from the upper, exterior glass pane to the lower, exterior glass pane on this solution is slightly less at 0.911″ (23.1 mm).

The present invention has the advantage that, starting with a conventional tilt & turn window, e.g., one of several European inspired, high performance REHAU tilt & turn window designs, and a few simple additional profiles, any of these can be transformed to resemble a traditional, North American style single or double-hung window when viewed from the exterior of a home or building. This simulated hung window retains all of the benefits of a tilt-turn window (high structural and thermal efficiency, twin, full perimeter compression type weather-seals, easy and safe cleaning of exterior glass surfaces from inside) while not requiring additional machinery or special tooling to a typical window fabricator's workshop. In addition, the simulated hung tilt-turn window provides the traditional aesthetics of a hung window without the functional and performance drawbacks from which many single & double-hung windows on the market suffer.

The present invention allows a manufacturer to build normal tilt & turn windows, consisting of a frame with four miter cut and fusion welded profiles, and a sash, also with four miter cut and fusion welded profiles. Those windows are completed by installing the off-the-shelf hardware mechanisms and then installing one insulated glass unit held in with a glazing stop profiles.

By adding a few small profiles to a fabricator's inventory, those same tilt & turn windows can be configured to make them resemble hung-sash windows when the specifications call for it. The following simple additional steps are required:
By cutting/processing and installing a middle mullion bar, divides the one large glass opening into two small ones.
The upper small glass opening would be finished by installing an insulated glass unit and glazing stop profiles.
The lower small glass opening would receive four pieces of “glazing rebate extension” profile, as well as four pieces of “glazing rebate filler” profile. These profiles create the 30 mm offset in the glazing channel necessary to give the finished window the appearance of a hung-sash window when viewed from the exterior of a building.

One unique feature of the present invention is that it would also allow existing tilt-turn windows with one glass unit to be converted into “simulated hung” windows, substituting the single glass for two using the simple steps above.

While two exemplary embodiments of the present invention are described above and illustrated in the accompanying drawings, clearly the present invention can be accomplished with other designs as would be appreciated by those skilled in the art based on this disclosure.

For example, while the foregoing embodiments are described with respect to a tilt and turn window, they can also be applied to a fixed frame window as would be appreciated by those skilled in the art based on this disclosure.

While the drawings shown preferred embodiments of the profiles and internal walls/webs of the window frame and sash, any suitable profiles and internal walls/webs can be used as would be appreciated by those skilled in the art based on this disclosure.

Also, while the embodiments above describe particular offsets, the offset distance can be adjusted based on the desired aesthetics. As an example only, the offset distance can be adjusted to a range of ¾ to 3″ (19 to 76.2 mm), preferably 1 to 2″ (25.4 to 50.8 mm).

What is claimed is:

1. A tilt and turn window, comprising:
a frame configured to be fixed to a building structure;
a sash unit cooperating with the frame;
a tilt mechanism attached to the frame and the sash unit configured to enable the sash unit to tilt about a horizontal axis to permit a top of the sash to tilt inwardly into the building structure to provide an opening between the top of the sash and the frame for ventilation;
a turn mechanism attached to the frame and the sash unit configured to enable the sash unit to turn about a vertical axis at one side of the sash unit;
a meeting rail unit provided in the sash unit and dividing the sash unit vertically into an upper sash portion and a lower sash portion, the meeting rail unit having an upper portion for securing an upper glazing unit in the upper sash portion, and a lower portion for securing a lower glazing unit in the lower sash portion;
an upper glazing unit secured in the upper sash portion of the sash unit; and
a lower glazing unit secured in the lower sash portion of the sash unit,
wherein the meeting rail unit is configured to provide an offset between the upper glazing unit and the lower glazing unit in a direction perpendicular to the horizontal axis and to the vertical axis, and
wherein an outside surface of the upper sash portion and an outside surface of the lower sash portion lie on the same plane.

2. The tilt and turn window according to claim 1, wherein the meeting rail unit is configured to offset the lower glazing unit inwardly with respect to the upper glazing unit in a direction perpendicular to the horizontal axis and to the vertical axis.

3. A fixed frame window, comprising:
a frame configured to be fixed to a building structure;
a sash unit fixed to the frame;
a meeting rail unit provided in the sash unit and dividing the sash unit vertically into an upper sash portion and a lower sash portion, the meeting rail unit having an upper portion for securing an upper glazing unit in the upper sash portion, and a lower portion for securing a lower glazing unit in the lower sash portion;
an upper glazing unit secured in the upper sash portion of the sash unit; and
a lower glazing unit secured in the lower sash portion of the sash unit,
wherein the meeting rail unit is configured to provide an offset between the upper glazing unit and the lower glazing unit in a direction perpendicular to the horizontal axis and to the vertical axis, and
wherein an outside surface of the upper sash portion and an outside surface of the lower sash portion lie on the same plane.

4. The fixed frame window according to claim 3, wherein the meeting rail unit is configured to offset the lower glazing unit inwardly with respect to the upper glazing unit in a direction perpendicular to the horizontal axis and to the vertical axis.
